(19) United States
(12) Patent Application Publication
(10) Pub. No.: US 2024/0200526 A1
(43) Pub. Date: Jun. 20, 2024

(54) Device and methods for converting hydraulic drag force into rotational force

(71) Applicant: Edward T. Tirpak, Louisburg, NC (US)

(72) Inventor: Edward T. Tirpak, Louisburg, NC (US)

(21) Appl. No.: 17/803,827

(22) Filed: Dec. 14, 2022

(51) Int. Cl. F03B 13/08; H02K 7/18

(52) U.S. Cl. CPC F03B 13/086; H02K 7/1823

(57) ABSTRACT

Devices and methods for converting hydraulic drag force into rotational force for the generation of electricity. A suction is created within a lumen, due to hydraulic drag force, when liquid passes by a lumen opening positioned under the surface of a moving liquid and facing the direction said liquid is moving toward. When such submerged lumen is connected to a turbine, this suction pulls liquids or gases through said turbine to create rotational force for electricity generation. Such rotational force can be increased and optimized by connecting multiple turbines with attached submerged lumens together as a Tirpak Turbine.

### BACKGROUND

Various and numerous issues relating to converting natural and sustainable energy into rotational force for electricity generation are known in the art. Among these issues are variability and unpredictability of wind-based sources of energy as well as negative environmental, wildlife and aesthetic impacts of devices designed to convert wind energy into rotational force to generate electricity and the cost of construction, maintenance and repair. Among these issues are also negative environmental, wildlife and aesthetic impacts of dams and devices designed to convert water-flow energy into rotational force to generate hydro-electric power as well as the cost of maintenance and repair and issues and limitations linked to the presence of ice, ice damage, ice formation, and corrosion and clogging of water intake and other components of hydroelectric energy generating devices and facilities. An additional issue for hydroelectric energy generation is difficulty in locating electricity generating equipment above or distant from the water source being relied upon to provide the energy used in hydroelectric energy generation. Accordingly, there is a needi n the art for improved energy sources, devices and methods for converting natural and sustainable energy into rotational force for the generation of electricity.

### BRIEF SUMMARY

When water or other liquid passes by a submerged opening of a tube or other structure having a lumen, such as, for example, when one end of a hose is positioned or submerged below the surface of the water while being towed by a boat moving over the surface of said water, a vacuum or vacuum-like force is generated that changes the pressure within said lumen such that air or other gases or water or other liquid is or may be drawn, pulled, moved or caused to be moved into one or more other opening(s) in said tube or other structure having a lumen and through said lumen.

Similarly, when water or other liquid passes by an opening of a tube or other structure having a lumen where said opening is positioned or submerged below the water surface of a moving river, stream or other body of water, such as a harbor inlet where tidal forces move water, or is positioned within an enclosed structure such as plumbing or other pipe structure where water or other liquid flows through such enclosed structure and past said opening of said tube or other structure having a lumen, a vacuum or vacuum-like force is generated that changes the pressure within said lumen such that air or other gases or water or other liquid is or may be may be drawn, pulled, moved or caused to be moved into one or more other opening(s) in said tube or other structure having a lumen and through said lumen.

Said vacuum or vacuum-like force, for convenience and without limitation, is referred to as “Hydraulic Drag Force”. Said water or other liquid that is moved, moves or passes by a submerged opening of a tube or other structure having a lumen, for convenience and without limitation, is referred to as “Drag Liquid”. Said elongated tube having a lumen and at least two lumen openings may be, for convenience and without limitation, referred to as a “Tirpak Tube” or as “Tirpak Tubes”. A turbine device having an enclosed internal cavity where liquid or gases can move through said internal cavity, an inflow opening where liquid or gases can enter said internal cavity, an outflow opening where liquid on gases can exit said internal cavity, turbine blades that cause the rotation of a turbine shaft when liquid or gases move through said internal cavity may be, for convenience and without limitation, referred to as a “Turbine Device” or as “Turbine Devices”.

Optimizing the conversion of Hydraulic Drag force into rotational force for electricity generation may be achieved by linking the turbine shafts of multiple Turbine Devices together, either in series or by connecting each turbine shaft to a separate drive shaft, and by connecting a linked turbine shaft or said separate drive shaft to the rotatable component of an electricity generating device. Multiple Turbine Devices, having a separate or combined Tirpak Tube connected to each said Turbine Device's outflow opening, linked together or connected to combine or increase rotational force may be referred to as a “Tirpak Turbine”.

Preferred embodiments of the present invention embody a device for converting hydraulic drag force into rotational force and generating electricity comprising: (1) a rotatable drive shaft connected to the rotatable component of an electricity generating device such that rotation of said rotatable drive shaft causes rotation of said rotatable component of said electricity generating device; (2) a Turbine Device having an enclosed internal cavity where liquid or gases can move through said internal cavity, an inflow opening where liquid or gases can enter said internal cavity, an outflow opening where liquid or gases can exit said internal cavity, turbine blades that cause the rotation of a turbine shaft when liquid or gases move through said internal cavity, and said turbine shaft being connected, directly or indirectly, to said drive shaft such that rotation of said turbine shaft causes the rotation of said drive shaft; and (3) a lumen opening of a Tirpak Tube attached to said outflow opening of said Turbine Device such that liquid or gases can move through said inflow opening, then through said internal cavity, then through said outflow opening, and then through the lumen of said Tirpak Tube, and with said Tirpak Tube having another lumen opening that can be positioned fully in or under the surface of a Drag Liquid such that said another lumen opening of said Tirpak Tube is positioned fully in or under the surface of said Drag Liquid and facing the direction that said Drag Liquid is moving toward.

Additional preferred embodiments of the present invention embody a method for converting hydraulic drag force into rotational force and generating electricity comprising, in any sequence, the following steps: (1) connecting a rotatable turbine shaft of a Turbine Device to the rotatable component of an electricity generating device such that rotation of said rotatable turbine shaft can cause rotation of said rotatable component of said electricity generating device; (2) attaching one opening of a Tirpak Tube having a lumen to the outflow opening of said Turbine Device such that liquid or gases can move through the internal cavity of said Turbine Device and cause the rotation of said Turbine Device's turbine blades and turbine shaft, then through said Turbine Device's outflow opening, then through the said lumen of said Tirpak Tube, and then out of said Tirpak Tube through another lumen opening; (3) positioning said another lumen opening of said Tirpak Tube fully in or below the surface of a Drag Liquid with said another lumen opening facing the direction said Drag Liquid is moving toward; and (4) moving said Drag Liquid or allowing said Drag Liquid to move past said another lumen opening positioned fully in or below the surface of said Drag Liquid to cause movement of liquid or gases into said Turbine Device's inflow opening, then through said Turbine Device's internal cavity, then through said Turbine Device's outflow opening, then through said Tirpak Tube's lumen, and then out of said Tirpak Tube's lumen and into said Drag Liquid.

Additional preferred embodiments of the present invention embody a device for converting hydraulic drag force into rotational force and generating electricity comprising: (1) a rotatable drive shaft connected to the rotatable component of an electricity generating device such that rotation of said rotatable drive shaft causes rotation of said rotatable component of said electricity generating device; (2) more than one Turbine Device, with each said Turbine Device having an enclosed internal cavity where liquid or gases can move through said internal cavity, an inflow opening where liquid or gases can enter said internal cavity, an outflow opening where liquid or gases can exit said internal cavity, and turbine blades that cause the rotation of a turbine shaft when liquid or gases move through said enclosed internal cavity, and with each said Turbine Device's turbine shaft connected, directly or indirectly, to said drive shaft such that liquid or gases moving through each said internal cavity of each said Turbine Device, causing rotation of each said Turbine Device's turbine shaft, causes rotation of said drive shaft; and (3) a lumen opening of a Tirpak Tube attached to each said outflow opening of each said Turbine Device such that liquid or gases can move through each said Turbine Device's said inflow opening, then through each said Turbine Device's said internal cavity, then through each said Turbine Device's said outflow opening, and then through the lumen of each said Tirpak Tube, and with each said Tirpak Tube having another lumen opening that can be positioned fully in or under the surface of a Drag Liquid such that each said another lumen opening of each said Tirpak Tube is positioned fully in or under the surface of said Drag Liquid and facing the direction that said Drag Liquid is moving toward.

Addition preferred embodiments of the present invention embody a method for converting hydraulic drag force into rotational force and generating electricity comprising, in any sequence, the following steps: (1) connecting a rotatable drive shaft to the rotatable component of an electricity generating device such that rotation of said rotatable drive shaft causes rotation of said rotatable component of said electricity generating device; (2) connecting said rotatable drive shaft to the turbine shaft of more than one Turbine Device in such a manner that rotation of each said turbine shaft causes the rotation of said drive shaft; (3) attaching to said outflow opening of each said Turbine Device a Tirpak Tube having a lumen and at least two lumen openings such that liquid or gases can move through each said Turbine Device's internal cavity and cause the rotation of each said Turbine Device's turbine blades and turbine shaft, then through each said Turbine Devices outflow opening, and then through the lumen of each said Tirpak Tube attached to each said Turbine Device; (4) positioning a lumen opening of each said Tirpak Tube, other than said lumen openings attached to each said outflow opening of each said Turbine Device, fully in or below the surface of a Drag Liquid and facing the direction said Drag Liquid is moving toward; (5) moving said Drag Liquid or allowing said Drag Liquid to move past each said lumen opening positioned fully in or below the surface of said Drag Liquid to cause movement of liquid or gases into each said Turbine Device's inflow opening, then through each said Turbine Device's internal cavity, then through each said Turbine Device's outflow opening, then through each said Tirpak Tube's lumen, and then out of each said Tirpak Tube's lumen and into said Drag Liquid.

### BRIEF DESCRIPTION OF THE DRAWINGS

FIG. 1 depicts a view of one preferred embodiment of the present invention and depicts an arrangement of a Tirpak Tube, a Turbine Device and an electricity generating device; and also depicts positioning of an opening of said Tirpak Tube in or below the surface of a Drag Liquid as well as a turbine shaft attached, connected or affixed, directly or indirectly to the rotatable portion of an electricity generating.

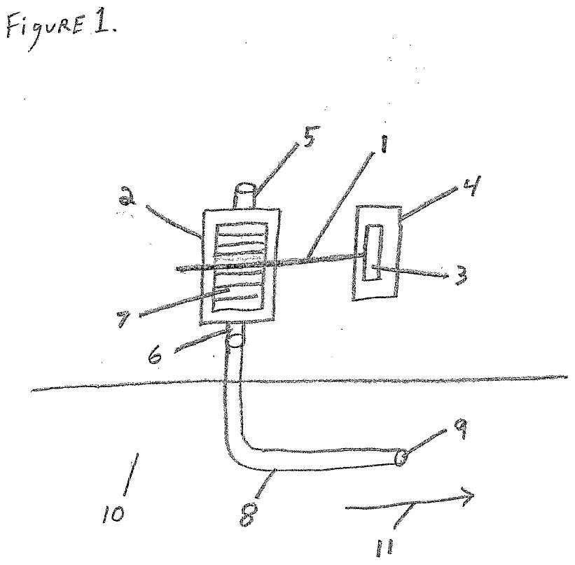

FIG. 2 depicts a view of another preferred embodiment of the present invention and depicts an arrangement of a Tirpak Tube, a Turbine Device and an electricity generating device; and depicts positioning of an opening of said Tirpak Tube in or below the surface of a Drag Liquid as well as a turbine shaft attached, connected on affixed, directly or indirectly to the rotating portion of an electricity generating device.

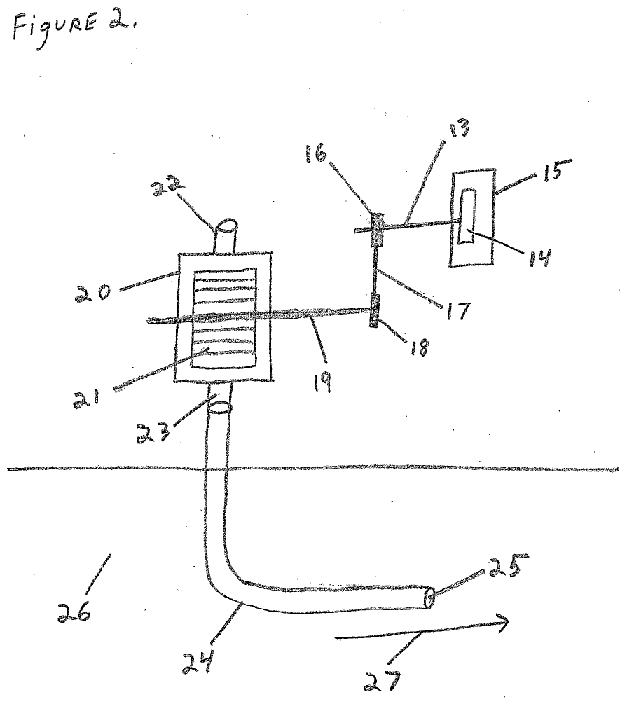

FIG. 3 depicts a view of another preferred embodiment of the present invention, and depicts an arrangement of multiple Tirpak Tubes, with each Tirpak Tube arranged with a lumen opening positioned below the surface of a Drag Liquid and each Tirpak Tube connected to a Turbine Device, depicts the turbine shaft of each said Turbine Device connected, attached or affixed to the turbine shaft of another Turbine Device, and depicts the turbine shaft of one said Turbine Device connected, attached or affixed, directly or indirectly, to the rotatable component of an electricity generating device.

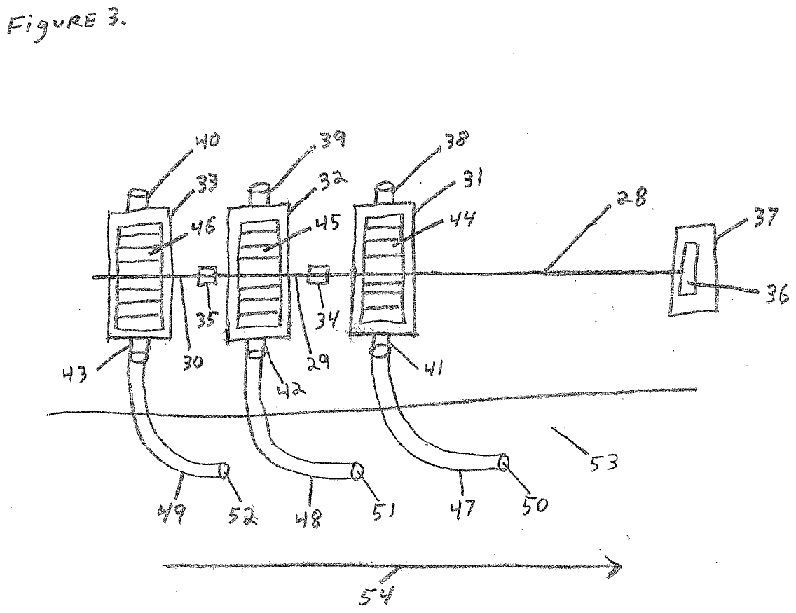

FIG. 4 depicts a view of another preferred embodiment of the present invention, and depicts an arrangement of multiple Tirpak Tubes, each positioned with an opening below the surface of a Drag Liquid and each Tirpak Tube connected to a Turbine Device, and depicts the turbine shaft of each said Turbine Device connected, attached or affixed to a rotatable drive shaft, and depicts said rotatable drive shaft connected, attached or affixed, directly or indirectly, to the rotatable component of an Electricity Generating Device.

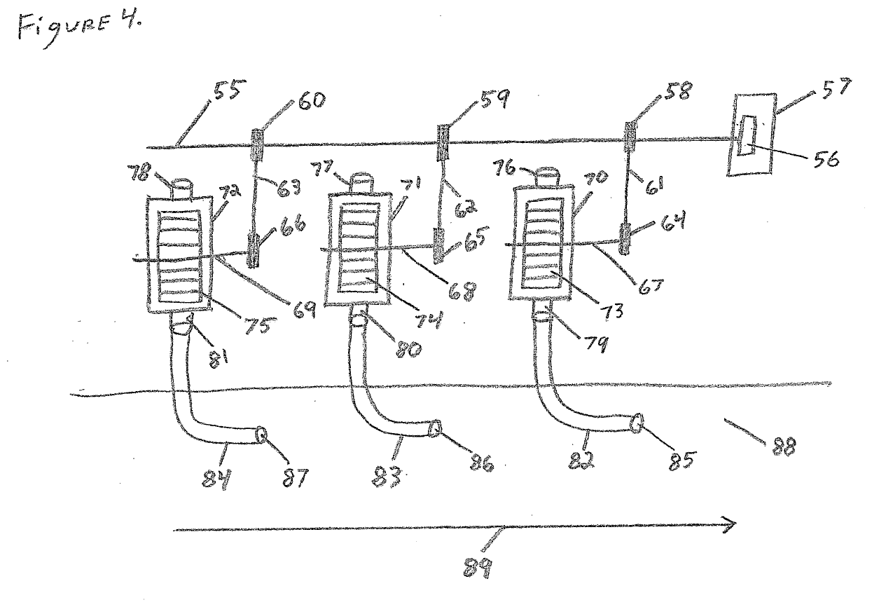

FIG. 5 depicts a cross section view of a portion of a Tirpak Tube having an enlarged diameter relative to another portion of said Tirpak Tube at a portion of said Tirpak Tube having an opening.

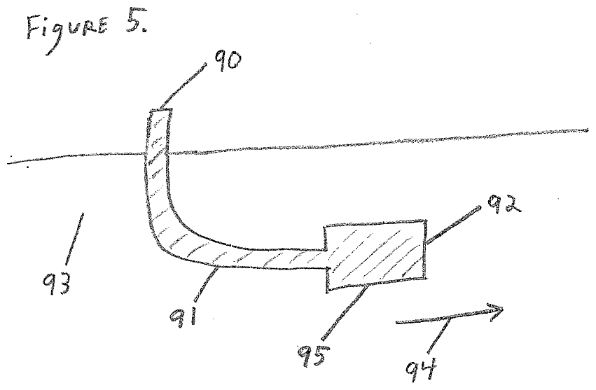

FIG. 6 depicts a cross section view of a portion of a Tirpak Tube having an opening positioned within an enclosed pipe structure.

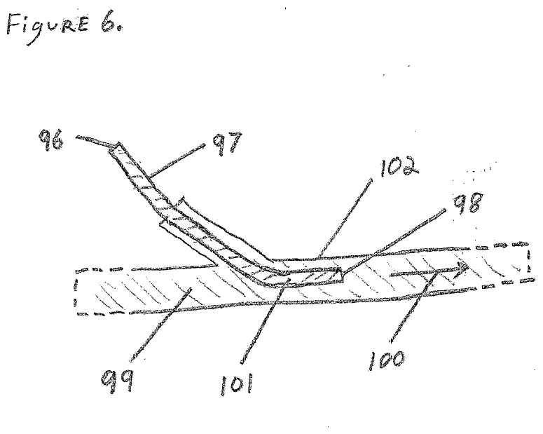

FIG. 7 depicts a cross section view of a portion of a Tirpak Tube having multiple openings structured and positioned for attachment to the outflow openings of multiple Turbine Devices, and depicts another portion of said Tirpak Tube having an opening structured for positioning in or below the surface of a Drag Liquid.

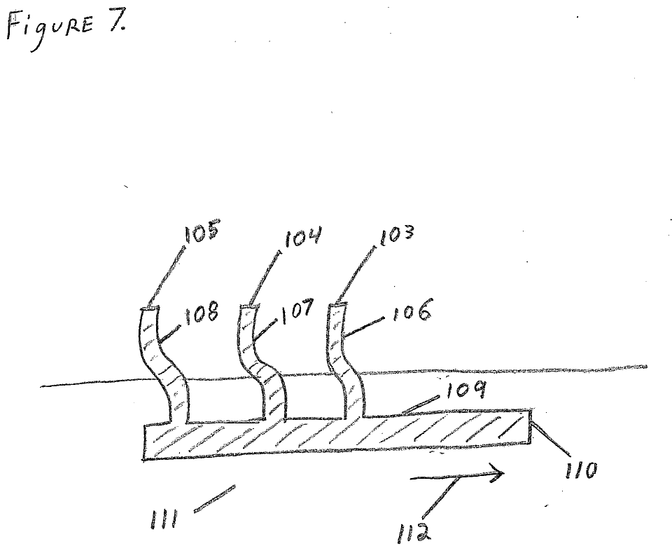

FIG. 8 depicts a cross sectional view of a tube having one end connected to the inflow opening of a Turbine Device and the other end of said tube submerged in liquid.

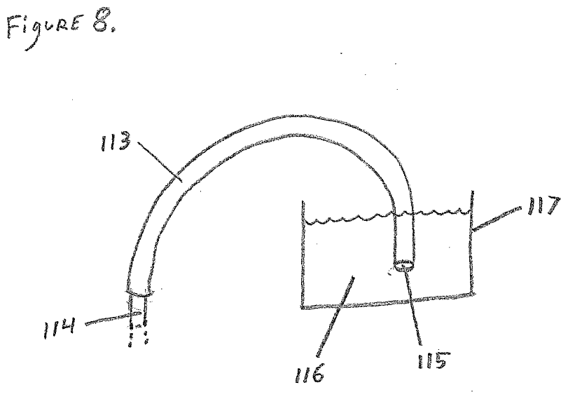

FIG. 9 depicts a view of a device for positioning an opening of each of multiple Tirpak Tubes below the surface of a Drag Liquid.

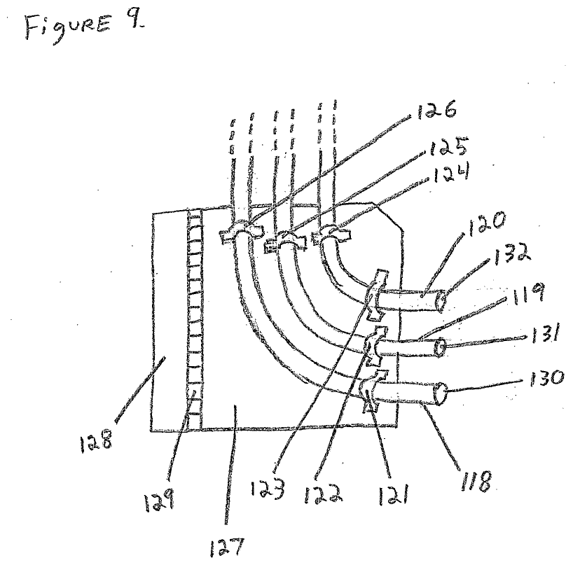

FIG. 10 depicts a view of an embodiment of a protective collar device capable of being affixed to a solid structure and positioned above and through and below the surface of a Drag Liquid and with said protective collar device positioned around a portion of a Tirpak Tube positioned above, through and below said surface of a Drag Liquid.

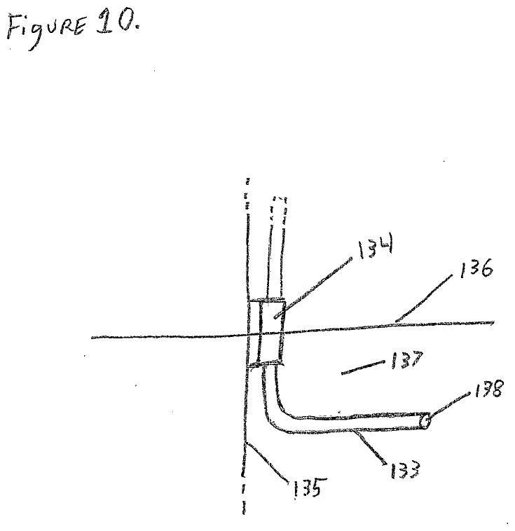

FIG. 11 depicts a view of an embodiment of an ice collar device affixed to and through an ice layer on the surface of a Drag Liquid and with said ice collar device positioned around a portion of a Tirpak Tube positioned above, through and below said ice layer.

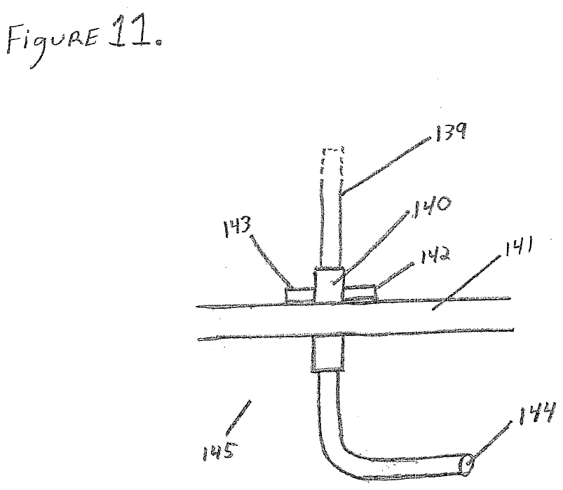

### DETAILED DESCRIPTION

### First Preferred Embodiment

In one preferred embodiment of the present invention a rotatable turbine shaft (1) is connected to a Turbine Device (2) and to the rotatable component (3) of an electricity generating device (4); said Turbine Device (2) has an inflow opening (5), an outflow opening (6), an internal cavity and turbine blades (7), with said Turbine Device (2), inflow opening (5), outflow opening (6), internal cavity and turbine blades (7) positioned and connected such that liquid or gases can move through said inflow opening (5) and through said internal cavity and out through said outflow opening (6), causing said turbine blades (7) and said turbine shaft (1) and said rotatable component (3) of said electricity generating device (4) to rotate; and said outflow opening (6) is connected to a lumen opening of a Tirpak Tube (8) that has another lumen opening (9) that can be positioned fully in or under the surface of a Drag Liquid (10) such that said another lumen opening (9) is fully in or under the surface of said Drag Liquid (10) and facing the direction (11) that said Drag Liquid (10) is moving toward.

### Second Preferred Embodiment

In another preferred embodiment of the present invention hydraulic drag force is converted into rotational force for the generation of electricity by carrying out, in any sequence, the following steps: connecting a rotatable turbine shaft (1) of a Turbine Device (2) to the rotatable component (3) of an electricity generating device (4) such that rotation of said rotatable turbine shaft (1) can cause rotation of said rotatable component (3) of said electricity generating device (4); attaching one opening of a Tirpak Tube (8) having a lumen to the outflow opening (6) of said Turbine Device (2) such that liquid or gases can move through the internal cavity of said Turbine Device (2), causing the rotation of turbine blades (7) and a turbine shaft (1), then through said outflow opening (6) of said Turbine Device (2), then through the said lumen of said Tirpak Tube (8), and then out of said elongated tube (8) through another lumen opening (9); positioning said another lumen opening (9) of said Tirpak Tube (8) fully in or below the surface of a Drag Liquid (10) with said another lumen opening (9) facing the direction (11) said Drag Liquid (10) is moving toward; and moving said Drag Liquid (10) or allowing said Drag Liquid (10) to move past said another lumen opening (9) positioned fully in or below the surface of said Drag Liquid (10).

Carrying out these steps causes liquid or gases to move through the inflow opening (5) of said Turbine Device (2), then through the internal cavity of said Turbine Device (2), causing the rotation of said turbine blades (7) and said turbine shaft (1), then through said outflow opening (6) of said Turbine Device (2), then through said lumen of said elongated tube (8), and then out of said elongated tube (8) through said another lumen opening (9); positioned fully in or below the surface of said Drag Liquid (10). Said rotation of said turbine shaft (1) causes the rotation of said rotatable component (3) of said electricity generating device (4) which causes the generation of electricity.

### Third Preferred Embodiment

In another preferred embodiment of the present invention a rotatable drive shaft (13) is connected to a rotatable component (14) of an electricity generating device (15) and to an affixed drive shaft pulley (16); a belt (17) is connected to said drive shaft pulley (16) and to a turbine shaft pulley (18); said turbine shaft pulley (18) is connected to a rotatable turbine shaft (19); said turbine shaft (19) is connected to a Turbine Device (20) and turbine blades (21) such that the rotation of said turbine blades (21) of said Turbine Device (20) cause the rotation of said turbine shaft (19); said Turbine Device (20) has an inflow opening (22), an outflow opening (23) and an internal cavity, with said inflow opening (22), outflow opening (23) and internal cavity positioned such that liquid or gases can move through said inflow opening (22) through said internal cavity and out through said outflow opening (23), causing said turbine blades (21) and turbine shaft (19) and said rotatable component (14) of said electricity generating device (15) to rotate; a lumen opening of a Tirpak Tube (24) is connected to said outflow opening (23) with said Tirpak Tube having another lumen opening (25) that can be positioned fully in or under the surface of a Drag Liquid (26) such that said another lumen opening (25) is fully in or under the surface of said Drag Liquid (26) and facing the direction (27) that said Drag Liquid (26) is moving toward.

### Fourth Preferred Embodiment

In another preferred embodiment of the present invention hydraulic drag force is converted into rotational force for the generation of electricity by carrying out, in any sequence, the following steps: connecting a rotatable drive shaft (13) to the rotatable component (14) of an electricity generating device (15) such that rotation of said rotatable drive shaft can cause the rotation of said rotatable component (14), connecting or affixing said drive shaft (13) to a drive shaft pulley (16); connecting a belt (17) to said drive shaft pulley (16) and to a turbine shaft pulley (18); connecting or affixing said turbine shaft pulley (18) to a rotatable turbine shaft (19) such that rotation of said turbine shaft (19) can cause rotation of said rotatable drive shaft (13); connecting said turbine shaft (19) to the turbine blades (21) of said Turbine Device such that the rotation of said turbine blades (21) can cause the rotation of said turbine shaft (19); attaching one opening of a Tirpak Tube (24) having a lumen to the outflow opening (23) of said Turbine Device (20) such that liquid or gases can move through the inflow opening (22), of said Turbine Device (20), through the internal cavity of said Turbine Device (20), causing rotation of said turbine blades (21) and turbine shaft (19), through the outflow opening (23) of said Turbine Device (20), then through the said lumen of said Tirpak Tube (24), and then out of said Tirpak Tube (24) through another lumen opening (25); positioning said another lumen opening (25) of said Tirpak Tube (24) fully in or below the surface of a Drag Liquid (26) with said another lumen opening (25) facing the direction (27) said Drag Liquid (26) is moving toward; and moving said Drag Liquid (26) or allowing said Drag Liquid (26) to move past said another lumen opening (25) positioned fully in or below the surface of said Drag Liquid (10).

Carrying out these steps causes liquid or gases to move through the inflow opening (22) of said Turbine Device (20), then through the internal cavity of said Turbine Device (20); causing the rotation of said turbine blades (21) and said turbine shaft (19), then through said outflow opening (23) of said Turbine Device (20), then through said lumen of said Tirpak Tube (24), and then out of said Tirpak Tube (24) through said lumen opening (25) positioned fully in or below the surface of said Drag Liquid (26). Said rotation of said turbine shaft (19) causes the rotation of said drive shaft (13) and the rotation of said rotatable component (14) of said electricity generating device (15) which causes the generation of electricity.

### Fifth Preferred Embodiment

In another preferred embodiment of the present invention a rotatable turbine shaft (28) (29) (30) is connected to each of more than one Turbine Device (31) (32) (33); each said rotatable turbine shaft (28) (29) (30) is connected to another said rotatable turbine shaft (28) (29) (30) by a coupler (34) (35); one said rotatable turbine shaft (28) is connected to the rotatable component (36) of an electricity generating device (37) such that rotation of said turbine shaft (28) can cause rotation of said rotatable component (36) of said electricity generating device (37); each said Turbine Device (31) (32) (33) has an inflow opening (38) (39) (40), an outflow opening (41) (42) (43), an internal cavity and turbine blades (44) (45) (46) connected to; a turbine shaft (28) (29) (30), with each said Turbine Device (31) (32) (33), inflow opening (38) (39) (40), outflow opening (41) (42) (43), internal cavity and turbine blades (45) (46) (47) positioned and connected such that liquid or gases can move through each said inflow opening (38) (39) (40) through each said internal cavity and out through each said outflow opening (41) (42) (43), causing the rotation of said turbine blades (45) (46) (47) and each turbine shaft (28) (29) (30) and said rotatable component (36) of said electricity generating device (37); and each said outflow opening (41) (42) (43) is connected to a lumen opening of a Tirpak Tube (47) (48) (49) that has another lumen opening (50) (51) (52) that can be positioned fully in or under the surface of a Drag Liquid (53) such that each said another lumen opening (50) (51) (52) is fully in or under the surface of said Drag Liquid (53) and facing the direction (54) that said Drag Liquid (53) is moving toward. For this preferred embodiment it is also contemplated that said rotatable turbine shafts (28) (29) (30) may comprise a single rotatable shaft connected to the turbine blades (44) (45) (46) of said Turbine Devices (31) (32) (33).

### Sixth Preferred Embodiment

In another preferred embodiment of the present invention hydraulic drag force is converted into rotational force for the generation of electricity by carrying out, in any sequence, the following steps: connecting each rotatable turbine shaft (28) (29) (30) to the turbine blades (44) (45) (46) of a Turbine Device (31) (32) (33); connecting each rotatable turbine shaft (28) (29) (30) of a Turbine Device (31) (32) (33) to another said turbine shaft (28) (29) (30); connecting one said turbine shaft (28) to the rotatable component (36) of an electricity generating device (37) such that rotation of said rotatable turbine shaft (28) can cause rotation of said rotatable component (36) of said electricity generating device (37); attaching one opening of a Tirpak Tube (47) (48) (49) having a lumen to the outflow opening (41) (42) (43) of each said Turbine Device (31) (32) (33) such that liquid or gases can move through each inflow opening (38) (39) (40) and through the internal cavity of each said Turbine Device (31) (32) (33), causing the rotation of said turbine blades (44) (45) (46) and turbine shafts (28) (29)/(30) and the rotatable component (36) of said electricity generating device (37), then through each said outflow opening (41) (42) (43) of each said Turbine Device (31) (32) (33), then through the said lumen of each said Tirpak (Tube (47) (48) (49), and then out through each said another lumen opening (50) (51) (52); positioning at least one said another lumen opening (50) (51) (52) fully in or below the surface of a Drag Liquid (553) with said at least one another lumen opening or lumen openings (50) (51) (52) facing the direction (54) said Drag Liquid (53) is moving toward; and moving said Drag Liquid (53) or allowing said Drag Liquid (53) to move past said at least one another lumen opening (50) (51) (52) positioned fully in or below the surface of said Drag Liquid (53).

Carrying out these steps causes liquid or gases to move through each said inflow opening (38) (39) (40) of each said Turbine Device (31) (32) (33), then through the internal cavity of each said Turbine Device (31) (32) (33), causing the rotation of said turbine blades (44) (45) (46) and said turbine shafts (28) (29) (30) and said rotatable component (36) of said electricity generating device (37), then through each said outflow opening (41) (42) (43) of each said Turbine Device (31) (32) (33), and then through the lumen of each said Tirpak Tube (47) (48) (49), and then out through each said another lumen opening (50) (51) (52) positioned fully in or below the surface of said Drag Liquid (53). Said rotation of said rotatable component (36) of said electricity generating device (37) causes the generation of electricity.

### Seventh Preferred Embodiment

In another preferred embodiment of the present invention a rotatable drive shaft (55) is connected to a rotatable component (56) of an electricity generating device (57) and to multiple affixed drive shaft pulleys (58) (59) (60); a belt (61) (62) (63) is connected to each said drive shaft pulley (58) (59) (60) and to each of several turbine shaft pulleys (64) (65) (66); each said turbine shaft pulley (64) (65) (66) is connected to a rotatable turbine shaft (67) (68) (69); each said turbine shaft (67) (68) (69) is connected to a Turbine Device (70) (71) (72) and turbine blades (73) (74) (75) such that the rotation of said turbine blades (73) (74) (75) of said Turbine Device (70) (71) (72) cause the rotation of said turbine shafts (67) (68) (69), said rotatable drive shaft (55) and said rotatable component (56) of said electricity generating device (57); each said Turbine Device (70) (71) (72) has an inflow opening (76) (77) (78), an outflow opening (79) (80) (81) and an internal cavity, with said inflow opening (76) (77) (78), outflow opening (79) (80) (81) and internal cavity positioned such that liquid or gases can move through each said inflow opening (76) (77) (78) through each said internal cavity and out through each said outflow opening (79) (80) (81), causing said turbine blades (73) (74) (75) and turbine shafts (67) (68) (69) and said drive shaft (55) and said rotatable component (56) of said electricity generating device (57) to rotate; a lumen opening of a Tirpak Tube (82) (83) (84) is connected to each said outflow opening (79) (80) (81) with each said Tirpak Tube (82) (83) (84 having another lumen opening (85) (86) (87) that can be positioned fully in or under the surface of a Drag Liquid (88) such that each said another lumen opening (85) (86) (87) is fully in or under the surface of said Drag Liquid (88) and facing the direction (89) that said Drag Liquid (88) is moving toward.

### Eighth Preferred Embodiment

In another preferred embodiment of the present invention hydraulic drag force is converted into rotational force for the generation of electricity by carrying out, in any sequence, the following steps: connecting a rotatable drive shaft (55) to the rotatable component (56) of an electricity generating device (57) such that rotation of said rotatable drive shaft (55) can cause the rotation of said rotatable component (56), connecting or affixing said drive shaft (55) to multiple drive shaft pulleys (58) (59)(60); connecting a belt (61) (62) (63) to each said drive shaft pulley (58) (59) (60) and to a turbine shaft pulley (64) (65) (66); connecting or affixing each said turbine shaft pulley (64) (65) (66) to a rotatable turbine shaft (67) (68) (69) such that rotation of each said turbine shaft (67) (68) (69) can cause rotation of said rotatable drive shaft (55) and said rotatable component (56) of said electricity generating device (57); connecting each said turbine shaft (67) (68) (69) to the turbine blades (73) (74) (75) of each said Turbine Device (70) (71) (72) such that the rotation of said turbine blades (73) (74) (75) can cause the rotation of each said turbine shaft (67) (68) (69) and the rotation of said drive shaft (55) and the rotation of said rotatable component (56) of said electricity generating device (57); attaching one opening of a Tirpak Tube (82) (83) (84) having a lumen to each said outflow opening (79) (80) (81) of each said Turbine Device (70) (71) (72) such that liquid or gases can move through each said inflow opening (76) (77) (78) of each said Turbine Device (70) (71) (72), through the internal cavity of each said Turbine Device (70) (71) (72), causing rotation of said turbine blades (73) (74) (75) and rotation of said turbine shafts (67) (68) (69) and rotation of said rotatable drive shaft (55) and rotatable component (56) of said electricity generating device (57), through the outflow opening (79) (80) (81) of each said Turbine Device (70) (71) (72), then through the said lumen of each said Tirpak Tube (82) (83) (84), and then out of the lumen of each said Tirpak Tube (82) (83) (84) through another lumen opening (85) (86) (87); positioning each said another lumen opening (85) (86) (87) of each said Tirpak Tube (82) (83) (84) fully in or below the surface of a Drag Liquid (88) with each said another lumen opening (82) (83) (84) facing the direction (89) said Drag Liquid (88) is moving toward; and moving said Drag Liquid (88) or allowing said Drag Liquid (88) to move past each said another lumen opening (82) (83) (84) positioned fully in or below the surface of said Drag Liquid (88).

Carrying out these steps causes liquid or gases to move through each inflow opening (76) (77) (78) of each said Turbine Device (70) (71) (72), then through the internal cavity of each said Turbine Device (70) (71) (72), causing the rotation of said turbine blades (73) (74) (75) and the rotation of each said turbine shaft (67) (68) (69) and the rotation of said drive shaft (55) and the rotation of said rotatable component (56) of said electricity generating device (57), then through each said outflow opening (79) (80) (81); of each said Turbine Device (70) (71) (72), then through each said lumen of each said Tirpak Tube (82) (83) (84), and then out of the lumens of each said Tirpak Tube (82) (83) (84) through each said lumen opening (85) (86) (87) positioned fully in or below the surface of said Drag Liquid (88). Said caused rotation of said rotatable component (56); of said electricity generating device (57) causes the generation of electricity.

Ninth preferred embodiment.

In another preferred embodiment or other preferred embodiments of the present invention a lumen opening (90) of a Tirpak Tube (91) is connected to an outflow opening of each of one or more Turbine Devices with each said Tirpak Tube (91) having another lumen opening (92) that can be positioned fully in or under the surface of a Drag Liquid (93); such that said another lumen opening (92) is fully in or under the surface of said Drag Liquid (93) and facing the direction (94) that said Drag Liquid (93) is moving toward, as described in other embodiments of the present invention, and, additionally; with a portion of said Tirpak Tube (95) near to and embodying said another lumen opening (92) being larger in diameter or other measure such that the cross-sectional area of the lumen of said Tirpak Tube (91) at said another lumen opening (92) is greater than the cross-sectional area of a lumen opening (90) connected to an outflow opening of at least one Turbine Device.

### Tenth Preferred Embodiment

In another preferred embodiment of the present invention hydraulic drag force is converted into rotational force for the generation of electricity by carrying out, in any sequence, the steps described in any other preferred embodiment or preferred embodiments, but where the Tirpak Tube or Tirpak Tubes used in carrying out the described steps is one or more Tirpak Tube or Tirpak Tubes (91) described in the Ninth preferred embodiment with said another lumen opening (92) being larger in diameter or other measure such that the cross-sectional area of the lumen of said Tirpak Tube (91) at said another lumen opening (92) is larger than the cross-sectional area of the lumen of at least one other portion of said Tirpak Tube (91).

### Eleventh Preferred Embodiment

In another preferred embodiment or other preferred embodiments of the present invention a lumen opening (96) of a Tirpak Tube (97) is connected to an outflow opening of each of one or more Turbine Devices with each said Tirpak Tube (97) having another lumen opening (98) that can be positioned fully in or under the surface of a Drag Liquid (99) such that said another lumen opening (98) is fully in or under the surface of said Drag Liquid (99) and facing the direction (100) that said Drag Liquid (99) is moving toward, as described in other embodiments of the present invention, and with a portion of said Tirpak Tube (101) near to and embodying said another lumen opening (98) being positioned within an enclosed pipe structure (102), through which said Drag Liquid (99) moves or can be moved in direction (100), such that said another opening (98) faces the direction (100) that said Drag Liquid moves or can be moved toward.

### Twelfth Preferred Embodiment

In another preferred embodiment of the present invention hydraulic drag force is converted into rotational force for the generation of electricity by carrying out, in any sequence, the steps described in any other preferred embodiment or preferred embodiments, but where a portion (101) of the Tirpak Tube or Tirpak Tubes used in carrying out the described steps is positioned within an enclosed pipe structure (102), through which said Drag Liquid (99) moves or can be moved in direction (100), such that said another opening (98) faces the direction (100) that said Drag Liquid (99) moves or can be moved toward.

### Thirteenth Preferred Embodiment

In another preferred embodiment or other preferred embodiments of the present invention, instead of the connection of Tirpak Tubes described in other preferred embodiments where a distinct Tirpak Tube is attached to the outflow opening of each separate Turbine Device, several lumen openings (103) (104) (105) of portions (106) (107) (108) of a single Tirpak Tube (109) are each connected to an outflow opening of a separate Turbine Device with said Tirpak Tube (109) having another lumen opening (110) that can be positioned fully in or under the surface of a Drag Liquid (111) such that said another lumen opening (110) is fully in or under the surface of said Drag Liquid (111) and facing the direction (112) that said Drag Liquid (111) is moving toward.

### Fourteenth Preferred Embodiment

In another preferred embodiment of the present invention hydraulic drag force is converted into rotational force for the generation of electricity by carrying out, in any sequence, the steps described in any other preferred embodiment or preferred embodiments, but where the Tirpak Tube or Tirpak Tubes used in carrying out the described steps is one or more Tirpak Tube or Tirpak Tubes described in the Thirteenth preferred embodiment (109) with said another lumen opening (110) positioned fully in or under the surface of a Drag Liquid (111) and facing the direction (112) that said Drag Liquid (111) is moving toward.

### Fifteenth Preferred Embodiment

In another preferred embodiment or other preferred embodiments of the present invention, a tube or other structure having a lumen (1113) is connected to the inflow opening (114) of the one or more Turbine Devices described in other preferred embodiments, with said tube or other structure having a lumen (114) also having an liquid intake lumen opening (115) capable of being places in an intake liquid (116) contained within an intake liquid reservoir (117) or other body of water or other source or body of liquid.

### Sixteenth Preferred Embodiment

In another preferred embodiment of the present invention hydraulic drag force is converted into rotational force for the generation of electricity by carrying out, in any sequence, the steps described in any other preferred embodiment or preferred embodiments, but as additional steps: a tube or other structure having a lumen (113) is connected to the intake opening (113) of one or more Turbine Devices; and the liquid intake lumen opening (115) of each said tube or other structure having a lumen (113) is positioned fully in or under the surface of an intake liquid (116).

### Seventeenth Preferred Embodiment

In another preferred embodiment or other preferred embodiments of the present invention a Tirpak Tube or Tirpak Tubes (118) (119) (120), as described in any other preferred embodiment or embodiments of the present invention, is or are connected or affixed by brackets (121) (122) (123) (124) (125) (126) or by other structures or devices known to persons having ordinary skill in the relevant art to a pivot device (127) which said pivot device has as a component a structure (128) capable of being attached or affixed to a solid structure and a hinge device (129) or other device that causes or allows the portion of said pivot device to which said Tirpak Tube or Tirpak Tubes (118) (119) (120) is or are connected or affixed to reposition, actively or passively, the direction of said Tirpak Tube or Tirpak Tubes (118) (119) (120) relative to said solid structure such that the lumen opening or lumen openings (130) (131) (132) of said Tirpak Tube or Tirpak Tubes (118) (119) (120) face toward the direction a liquid said lumen openings (130) (130) (132) are position fully in or under the surface of is moving toward.

### Eighteenth Preferred Embodiment

In another preferred embodiment of the present invention hydraulic drag force is converted into rotational force for the generation of electricity by carrying out, in any sequence, the steps described in any other preferred embodiment or preferred embodiments, but where, as additional steps, one or more Tirpak Tube or Tirpak Tubes used in carrying out the described steps is or are connected or affixed to a pivot device (127) described in the Seventeenth preferred embodiment and said pivot device (127) is connected or affixed to a solid structure.

### Nineteenth Preferred Embodiment

In another preferred embodiment or other preferred embodiments of the present invention a Tirpak Tube or Tirpak Tubes (133), as described in any other preferred embodiment or embodiments of the present invention, is on are partly or fully surrounded by a protective collar (134) capable of being attached or affixed to a solid structure (135) and having sufficient length to be positioned such that said protective collar (134) extends both above and below the surface (136) of a liquid (137) and the open lumen (138) of said Tirpak Tube or Tirpak Tubes (133) may be positioned in or fully below the surface (136) of said liquid (137). Said protective collar (134) is most ideally made of stainless steel or iron or other materials known to persons having ordinary skill in the relevant art and having sufficient thickness and strength to protect said Tirpak Tube or Tirpak Tubes (133) from compressive forces of ice forming around said Tirpak Tube or Tirpak Tubes (133) at or near the surface (136) of said liquid (137) and from damage or dislodging that may otherwise result from moving ice, tree limbs or other materials coming in contact with said Tirpak Tube or Tirpak Tubes (133).

### Twentieth Preferred Embodiment

In another preferred embodiment of the present invention hydraulic drag force is converted into rotational force for the generation of electricity by carrying out, in any sequence, the steps described in any other preferred embodiment or preferred embodiments, but where, as an additional step, one or more Tirpak Tube or Tirpak Tubes (133) used in carrying out the described steps is or are partly or fully surrounded by a protective collar (134) described in the Twentieth preferred embodiment and attached or affixed to a solid structure (135).

### Twenty-First Preferred Embodiment

In another preferred embodiment or other preferred embodiments of the present invention a Tirpak Tube or Tirpak Tubes (139), as described in any other preferred embodiment or embodiments of the present invention, is on are partly or fully surrounded by an ice collar (140) capable of being connected or affixed to surface ice (141) or having a structure or structures (142) (143) to prevent said ice collar (140) from falling through said surface ice (141) and with said ice collar (140) having sufficient length to be positioned such that said ice collar (140) extends both above and below said surface ice (141) and the open lumen (144) of said Tirpak Tube or Tirpak Tubes (139) may be positioned in or fully below the surface of the liquid (145) under said surface ice (141). Said ice collar (140) most ideally is made of stainless steel or iron or other materials known to persons having ordinary skill in the relevant art and having sufficient thickness and strength to protect said Tirpak. Tube or Tirpak Tubes (139) from compressive forces of ice forming around said Tirpak Tube or Tirpak Tubes (139) at or near the surface of said liquid (145).

### Twenty-Second Preferred Embodiment

In another preferred embodiment of the present invention hydraulic drag force is converted into rotational force for the generation of electricity by carrying out, in any sequence, the steps described in any other preferred embodiment or preferred embodiments, but where, as an additional step, one or more Tirpak Tube or Tirpak Tubes (139) used in carrying out the described steps is or are partly or fully surrounded by an ice collar (140) described in the Twenty-first preferred embodiment and connected to or affixed to or positioned through surface ice (141).

### Miscellaneous.

A Tirpak Tube or Tirpak Tubes must have sufficient strength and firmness of its or their structure to withstand external pressure resulting from reduced internal pressure resulting from Hydraulic Drag Force without fully collapsing or otherwise fully blocking the flow of air or other gases or water on other liquid moving through said Tirpak Tube or Tirpak Tubes.

Other than said strength and firmness requirements, a Tirpak Tube or Tirpak Tubes may have any number or variation of forms or shape, any number or variation of lengths or dimensions, any number or variation of internal dimensions, any number or variation of lumen openings, any amount of flexibility or rigidity, be made from any number or variety of materials, may be free-floating or partly or fully affixed to any number or variation of structures, and may have any number or variation of additional features or components such as valves, fittings, couplers, flow regulators, fins or stabilizers, without limitation.

For all preferred embodiments when a lumen opening of a tube having a lumen, whether said tube is a Tirpak Tube or other tube, is connected to an inflow opening of a Turbine Device or to an outflow opening of a Turbine Device it is contemplated that such connection is airtight or water-tight such that vacuum force or suction can be maintained to the extent possible within, through and across such point of connection. An example is an outflow opening of a Turbine Device comprising a metal pipe having an opening, a Tirpak Tube that is a segment of a flexible rubberized industrial hose that has been cut to have two lumen openings, one on each end, a lumen opening of said Tirpak Tube fitted around the outside of said metal pipe having an opening such that said metal pipe is partly inside the lumen of said Tirpak Tube, and the portion of said Tirpak Tube fitted around and enclosing a portion of said metal pipe being held in place by a fitted and tightened hose clamp.

It is contemplated that many and varying sizes, shapes, forms, variations, and types of turbines known to persons having ordinary skill in the relevant art may be incorporated into embodiments of the present invention.

The affixation, connection or attachment of a turbine shaft to a drive shaft, or of a turbine shaft to another turbine shaft, or of a drive shaft to a rotatable component of an electricity generating device is contemplated to comprise one or more pullies, belts, gears, chains, couplers or other device or devices, electronic or mechanical and without limitation, commonly known to persons having ordinary skill in the relevant art. The inclusion of the word “pulley” or “pullies” or “belt” or “belts” is intended only to be exemplary and not in any way limiting.

For embodiments of the present invention where more than one turbine shaft is affixed, connected or attached to a rotatable drive shaft it is contemplated that one or more slip gears, such as is used in bicycles so the rear wheel on tire may rotate while the chain and peddles remain stationary; may be included in the connection of each said turbine shaft to said rotatable drive shaft so any malfunction or inefficiency in the functioning of one connected Turbine Device has a limited impact on the functioning and efficiency of the rotation of said drive shaft and on the generation of electricity. It is also contemplated that a drive shaft may be any number of rotatable shafts connected to each other by one or more couplers, gears, chains, pulleys, belts or other devices or mechanisms known to individuals having ordinary skill in the relevant art.

For each embodiments of the present invention where a single rotatable drive shaft is positioned through the center of more than one Turbine Device or where more than one Turbine Device having a turbine shaft are connected in series such that multiple turbine shafts function as a single drive shaft positioned through the center of more than one Turbine Device, the portion of each such Turbine Device that connects the turbine blades to the rotatable drive shaft or to the turbine shaft may be considered to be the “turbine shaft” for that embodiment of the present invention and the rotatable drive shaft positioned through the center of more than one Turbine Device or the turbine shafts connected in series such that multiple turbine shafts function as a single drive shaft may be considered to be the “drive shaft” for that embodiment of the present invention.

For all embodiments of the present invention it is contemplated that a rotatable shaft or more than one rotatable shaft, whether a drive shaft or a turbine shaft, or any mechanism or device for transferring rotational force from at least one Turbine Device to the rotatable component of an electricity generating device may be positioned or connected on or to one side, the other side, either side, both sides, through or around said rotatable component of said electricity generating device.

For all embodiments of the present invention that have more than one Turbine Device, it is contemplated that the rotatable component of an electricity generating device may be positioned or connected at any location relative to said Turbine devices, such as for example, at either side or between said Turbine devices, or, in some configurations, alongside said Turbine Devices.

For all embodiments of the present invention it is contemplated that a rotatable component of an electricity generating device may mean any number of rotatable components of any number of electricity generating devices.

For all embodiments of the present invention it is contemplated that, in addition to one or more Tirpak Tubes being positioned in or under the surface of a Drag Liquid, one or more Turbine Devices may be positioned in or under the surface of a Drag Liquid and, optionally, an intake opening of one or more said Turbine Devices may have an attached tube having a lumen with another opening of said attached tube positioned above or below the surface of a Drag Liquid or other liquid so that air or other gases or liquid may move through said attached tube and said Turbine device.

For all embodiments of the present invention it is contemplated that an electricity generating device may comprise any type of generator or alternator, and may include any device, mechanism, system, method, process or technology, without limitation, that influences the functioning or efficiency of said electricity generating device known to persons having ordinary skill in the art such as, for example, devices and mechanisms to optimize or regulate the rotational speed of any components of said electricity generating device.

I claim:

1. A device for converting hydraulic drag force into rotational force and generating electricity comprising: (1) a rotatable drive shaft connected to the rotatable component of an electricity generating device such that rotation of said rotatable drive shaft causes rotation of said rotatable component of said electricity generating device; (2) a Turbine Device having an enclosed internal cavity where liquid or gases can move through said internal cavity, an inflow opening where liquid or gases can enter said internal cavity, an outflow opening where liquid or gases can exit said internal cavity, turbine blades that cause the rotation of a turbine shaft when liquid or gases move through said internal cavity, and said turbine shaft being connected, directly or indirectly, to said drive shaft such that rotation of said turbine shaft causes the rotation of said drive shaft; and (3) a lumen opening of a Tirpak Tube attached to said outflow opening of said Turbine Device such that liquid or gases can move through said inflow opening, then through said internal cavity, then through said outflow opening, and then through the lumen of said Tirpak Tube, and with said Tirpak Tube having another lumen opening that can be positioned fully in or under the surface of a Drag Liquid such that said another lumen opening of said Tirpak Tube is positioned fully in or under the surface of said Drag Liquid and facing the direction that said Drag Liquid is moving toward.

2. The device of claim 1, further comprising: said another lumen opening being larger in diameter or other measure than said lumen opening attached to said outflow opening such that the cross-sectional area of said another lumen opening is greater than the cross-sectional area of said lumen opening attached to said outflow opening.

3. The device of claim 1, further comprising: a Tirpak Tube connected to a pivot device with said pivot device having a component capable of being attached to a solid structure and a hinge device that causes or allows the portion of said pivot device to which said Tirpak Tube is connected to reposition, actively or passively, a portion of said Tirpak Tube relative to said solid structure such that said another lumen opening is facing the direction said Drag Liquid is moving toward.

4. The device of claim 1, further comprising: a Tirpak Tube being partly or fully surrounded by a protective collar capable of being attached to a solid structure and with said protective collar having sufficient length to be positioned such that said protective collar extends both above and below the surface of a Drag Liquid.

5. The device of claim 2, further comprising: a Tirpak Tube connected to a pivot device with said pivot device having a component capable of being attached to a solid structure and a hinge device that causes or allows the portion of said pivot device to which said Tirpak Tube is connected to reposition, actively or passively, a portion of said Tirpak Tube relative to said solid structure such that said another lumen opening is facing the direction said Drag Liquid is moving toward.

6. A method for converting hydraulic drag force into rotational force and generating electricity comprising, in any sequence, the following steps: (1) connecting a rotatable turbine shaft of a Turbine Device to the rotatable component of an electricity generating device such that rotation of said rotatable turbine shaft can cause rotation of said rotatable component of said electricity generating device; (2) attaching one opening of a Tirpak Tube having a lumen to the outflow opening of said Turbine Device such that liquid or gases can move through the internal cavity of said Turbine Device and cause the rotation of said Turbine Device's turbine blades and turbine shaft, then through said Turbine Device's outflow opening, then through the said lumen of said Tirpak Tube, and then out of said Tirpak Tube through another lumen opening; (3) positioning said another lumen opening of said Tirpak Tube fully in or below the surface of a Drag Liquid with said another lumen opening facing the direction said Drag Liquid is moving toward; and (4) moving said Drag Liquid or allowing said Drag Liquid to move past said another lumen opening positioned fully in or below the surface of said Drag Liquid to cause movement of liquid or gases into said Turbine Device's inflow opening, then through said Turbine Device's internal cavity, then through said Turbine Device's outflow opening, then through said Tirpak Tube's lumen, and then out of said Tirpak Tube's lumen and into said Drag Liquid.

7. The method of claim 6, further comprising: said another lumen opening being larger in diameter or other measure than said one opening of a Tirpak Tube such that the cross-sectional area of said another lumen opening is greater than the cross-sectional area of said one opening of a Tirpak Tube.

8. The method of claim 6, further comprising, in any sequence, the following additional steps: (1) connecting a Tirpak Tube to a pivot device with said pivot device having a component capable of being attached to a solid structure and a hinge device that causes or allows the portion of said pivot device to which said Tirpak Tube is connected to reposition, actively or passively, a portion of said Tirpak Tube relative to said solid structure such that said another lumen opening is facing the direction said Drag Liquid is moving toward; and (2) attaching to a solid structure said component capable of being attached to a solid structure.

9. The method of claim 6, further comprising, in any sequence, the following additional steps: (1) inserting a Tirpak Tube through a protective collar capable of being attached to a solid structure and with said protective collar having sufficient length to be positioned to extend both above and below the surface of a Drag Liquid such that said protective collar partly or fully surrounds said Tirpak Tube; and (2) attaching to a solid structure said protective collar such that said protective collar extends both above and below the surface of a Drag Liquid.

10. The method of claim 7, further comprising, in any sequence, the following additional steps: (1) connecting a Tirpak Tube to a pivot device with said pivot device having a component capable of being attached to a solid structure and a hinge device that causes or allows the portion of said pivot device to which said Tirpak Tube is connected to reposition, actively or passively, a portion of said Tirpak Tube relative to said solid structure such that said another lumen opening is facing the direction said Drag Liquid is moving toward; and (2) attaching to a solid structure said component capable of being attached to a solid structure.

11. A device for converting hydraulic drag force into rotational force and generating electricity comprising: (1) a rotatable drive shaft connected to the rotatable component of an electricity generating device such that rotation of said rotatable drive shaft causes rotation of said rotatable component of said electricity generating device; (2) more than one Turbine Device, with each said Turbine Device having an enclosed internal cavity where liquid or gases can move through said internal cavity, an inflow opening where liquid or gases can enter said internal cavity, an outflow opening where liquid or gases can exit said internal cavity, and turbine blades that cause the rotation of a turbine shaft when liquid or gases move through said enclosed internal cavity, and with each said Turbine Device's turbine shaft connected, directly or indirectly, to said drive shaft such that liquid or gases moving through each said internal cavity of each said Turbine Device, causing rotation of each said Turbine Device's turbine shaft, causes rotation of said drive shaft; and (3) a lumen opening of a Tirpak Tube attached to each said outflow opening of each said Turbine Device such that liquid or gases can move through each said Turbine Device's said inflow opening, then through each said Turbine Device's said internal cavity; then through each said Turbine Device's said outflow opening, and then through the lumen of each said Tirpak Tube, and with each said Tirpak Tube having another lumen opening that can be positioned fully in or under the surface of a Drag Liquid such that each said another lumen opening of each said Tirpak Tube is positioned fully in or under the surface of said Drag Liquid and facing the direction that said Drag Liquid is moving toward.

12. The device of claim 11, further comprising: at least one said another lumen opening being larger in diameter or other measure than at least one said lumen opening attached to said outflow opening such that the cross-sectional area of said another lumen opening is greater than the cross-sectional area of said lumen opening attached to said outflow opening.

13. The device of claim 11, further comprising: a Tirpak Tube connected to a pivot device with said pivot device having a component capable of being attached to a solid structure and a hinge device that causes or allows the portion of said pivot device to which said Tirpak Tube is connected to reposition, actively or passively, a portion of said Tirpak Tube relative to said solid structure such that said another lumen opening is facing the direction said Drag Liquid is moving toward.

14. The device of claim 12, further comprising: a Tirpak Tube connected to a pivot device with said pivot device having a component capable of being attached to a solid structure and a hinge device that causes or allows the portion of said pivot device to which said Tirpak Tube is connected to reposition, actively or passively, a portion of said Tirpak Tube relative to said solid structure such that said another lumen opening is facing the direction said Drag Liquid is moving toward.

15. The device of claim 11, further comprising: several lumen openings of portions of a single Tirpak Tube each connected to an outflow opening of a separate Turbine Device with said Tirpak Tube having another lumen opening that can be positioned fully in or under the surface of a Drag Liquid such that said another lumen opening is fully in or under the surface of said Drag Liquid and facing the direction that said Drag Liquid is moving toward.

16. A method for converting hydraulic drag force into rotational force and generating electricity comprising, in any sequence, the following steps: (1) connecting a rotatable drive shaft to the rotatable component of an electricity generating device such that rotation of said rotatable drive shaft causes rotation of said rotatable component of said electricity generating device; (2) connecting said rotatable drive shaft to the turbine shaft of more than one Turbine Device in such a manner that rotation of each said turbine shaft causes the rotation of said drive shaft; (3) connecting to said outflow opening of each said Turbine Device a lumen opening of a Tirpak Tube having a lumen and at least two lumen openings such that liquid or gases can move through each said Turbine Device's internal cavity and cause the rotation of each said Turbine Device's turbine blades and turbine shaft, then through each said Turbine Devices outflow opening, and then through the lumen of each said Tirpak Tube connected to each said Turbine Device; (4) positioning a lumen opening of each said Tirpak Tube, other than said lumen openings connected to each said outflow opening of each said Turbine Device, fully in or below the surface of a Drag Liquid and facing the direction said Drag Liquid is moving toward; (5) moving said Drag Liquid or allowing said Drag Liquid to move past each said lumen opening positioned fully in or below the surface of said Drag Liquid to cause movement of liquid or gases into each said Turbine Device's inflow opening, then through each said Turbine Device's internal cavity, then through each said Turbine Device's outflow opening, then through each said Tirpak Tube's lumen, and then out of each said Tirpak Tube's lumen and into said Drag Liquid.

17. The method of claim 16, further comprising: each lumen opening of each said Tirpak Tube, other than said lumen openings attached to each said outflow opening of each said Turbine Device, positioned fully in or below the surface of a Drag Liquid and facing the direction said Drag Liquid is moving toward being larger in diameter or other measure than each said lumen opening attached to each said outflow opening of each said Turbine Device such that the cross-sectional area of each lumen opening of each said Tirpak Tube, other than said lumen openings attached to each said outflow opening of each said Turbine Device, positioned fully in or below the surface of a Drag Liquid and facing the direction said Drag Liquid is moving toward is greater than the cross-sectional area of each said lumen opening attached to each said outflow opening of each said Turbine Device.

18. The method of claim 16, further comprising, in any sequence, the following additional steps: (1) connecting a Tirpak Tube to a pivot device with said pivot device having a component capable of being attached to a solid structure and a hinge device that causes or allows the portion of said pivot device to which said Tirpak Tube is connected to reposition, actively or passively, a portion of said Tirpak Tube relative to said solid structure such that said another lumen opening is facing the direction said Drag Liquid is moving toward; and (2) attaching to a solid structure said component capable of being attached to a solid structure.

19. The method of claim 17, further comprising, in any sequence, the following additional steps: (1) connecting a Tirpak Tube to a pivot device with said pivot device having a component capable of being attached to a solid structure and a hinge device that causes or allows the portion of said pivot device to which said Tirpak Tube is connected to reposition, actively or passively, a portion of said Tirpak Tube relative to said solid structure such that said another lumen opening is facing the direction said Drag Liquid is moving toward; and (2) attaching to a solid structure said component capable of being attached to a solid structure.

20. The method of claim 16, further comprising: said Tirpak Tube being a single Tirpak Tube having a separate lumen opening for connection to each to said outflow opening of each said Turbine Device and with said Tirpak Tube having another lumen opening that can be positioned fully in or under the surface of a Drag Liquid such that said another lumen opening is fully in or under the surface of said Drag Liquid and facing the direction that said Drag Liquid is moving toward.
